(19) United States
(12) Patent Application Publication
(10) Pub. No.: US 2005/0215160 A1
(43) Pub. Date: Sep. 29, 2005

(54) Higher-performance spark plug and ramrod engine ignition system using piezo-electric enhancement components

(76) Inventor: Colonel Terry Kolp, Philadelphia, PA (US)

Correspondence Address: Colonel Terry Kolp;The Ben Franklin House, Suite 1409, 834 Chestnut Street, Philadelphia, PA, 19107, US

(21) Appl. No.: 10/810,565

(22) Filed: Mar. 29, 2004

(51) Int. Cl. H01T 21/02; F02P 15/08

(52) U.S. Cl. 445/7

(57) ABSTRACT

This invention constitutes improvements and innovates with novel preferred embodiments the use of a new spark plug casting mold and process—using either wax or recycled plastic resins for more flexibly casting the bulk of this novel spark plug design and its corresponding now unique method of manufacture. A utility invention and design for providing new improved spark plug(s) and engine ignition components configured in a new manner and for/and as an internal combustion engine ignition system(s); that specifically are also unique and novel in both design configuration(s), some operation(s), method(s) of manufacture and product(s) assembly; plus also novel and original in the specific chemistry of some metal alloy formulas; and the componentization(s) of some of this/these new combined spark plug/ignition system configuration(s) with unique and novel piezo-electric components. This/these invention(s) also constitutes improvements and innovates with novel preferred embodiments the use of a new spark plug casting mold and process-using either wax or recycled plastic resins for more flexibly casting the bulk of this novel spark plug design and its corresponding now unique method of manufacture. The objects and advantages of new comprehensive design and unique manufacturing configuration processes will also incorporate and demonstrate an improved satisfactory spark plug and engine ignition system electrode(s) which can be efficiently manufactured and can be accomplished by fuse-weld connection continuity/welding of a wire around the center electrode. Which in a variant of this novel patent design configuration will result in improvements in the electron flow or spark to emanate or to “ramrod” “shoot-out” like a “shooting star or rocket” in comparison to all conventional and all prior spark plug designs, configurations and engine ignition system performance and operation(s). Thus, both an improved spark plug and ignition system performance is/are provided.

### FEDERALLY SPONSORED RESEARCH

Not Applicable

### SEQUENCE LISTING OR PROGRAM

Not Applicable

### BACKGROUND

1. Field of Invention

This invention relates to an improved higher-performance spark plug and engine ignition system, employing the inventor's improved spark plug design, method of manufacture and assembly, utility configuration(s) and engine ignition system using piezoelectric enhancement configuration(s) and component(s).

This invention relates to a new improved utility design for spark plug(s) and engine ignition components configured in a new manner and as an internal combustion engine ignition system; that specifically is also unique and novel in both design configuration(s), method(s) of manufacture and assembly; plus also novel and original in the specific chemistry of the metal alloy formulas; and the componentization(s) of this new combined spark plug/ignition system configuration(s) with unique and novel piezo-electric components.

2. Description of Prior Art

The spark plug is an essential component to any internal combustion engine usually gasoline and such hydrocarbon fuels powered. In order for an engine to convert gasoline to energy, it must burn in explosion a mixture of fuel and air. The spark plug component performs two primary functions:
Conducts and delivers electrical energy current to ignite the air/fuel mixture to produce specifically timed and adequate chambered explosion(s), etc.
Conducts sufficient heat from its elements exposed in the combustion chamber(s) cylinder(s) to prevent any subsequent fuel/air mixture(s) from detonating prior to the next timed spark-ignition, etc. The spark plug is simple in theory. It forces electricity to arc across a gap, like a short-bolt of lightning. The electricity must be at a very high voltage in order to travel across the gap and yield a spark. Voltages used for spark plugs range from 2,000 to 100,000 volts.

The spark plug must have an insulated passageway for the high voltage to travel down to the electrode, where it can jump the gap and, from there, being conducted into the engine block and grounded. The plug also has to withstand the extreme heat and pressures inside the cylinder, and it must be designed so that deposits from fuel additives and incompletely burned and unburned fuel portions do not deposit as build-up on the plug, itself, and elsewhere, etc.

Conventional spark plugs traditionally use a ceramic insert to isolate or contain the high voltage at the electrode, ensuring that the spark occurs at the tip of the electrode and not anywhere else on the plug; this insert does double-duty by helping to oxidize and to burn off deposits. Ceramic is a comparatively poor heat conductor, so the ceramic material becomes very hot during operation. This heat also contributes to the high temperature oxidation and burn-off of deposits from the individual spark plug electrode(s). In addition, the spark plug itself also acts as a heat exchanger and pulls a portion of the unwanted heat from the combustion chamber and transfers/dissipates it to the engine block by direct conduction and by convection transfers to the engine's cooling system. The heat range is the plugs ability to tolerate and dissipate heat; thus preventing detonation of fuel/air mixtures prior to the next designated optimal timed spark.

Each engine uses a spark plug that Is specifically designated and/or designed for that specific engine or motor, combustion chamber shape and depth, etc. Factors such as heat ranges and gap lengths will vary for different engine types, models, sizes, compression ratios, performance and criteria. For example, some engines require a hot or hotter temperature performing spark plug. This type of plug is designed with a ceramic insert that has a smaller contact area with the metal part of the plug. This reduces the heat transfer from the ceramic, making it run hotter and thus burn away more deposits.

Cold plugs are designed with more contact area, so they run cooler. The previous conventional spark plugs are imprecise instruments. Over the years, manufacturers have only made improvements adding new metals such as platinum, changing gap sizes, and adding electrodes.

There is an oval ring design in U.S. Pat. No. 5,280,214 to Johnson (1994). A spark plug for an internal combustion engine wherein a ring-shaped ground electrode with a uniform annular hole with an internal diameter about 0.80 to 1.25 the outer diameter of the center electrode. The ground electrode is vertically spaced below the center electrode and is concentric therewith. The ground electrode is connected to one or more mounting posts attached to a spark plug metal housing. The spark from the center electrode to the ground electrode has multiple paths and resulting in a functioning spark plug. It does not consist what is now in this patent application.

There is only an oval ring design in U.S. Pat. No. 5,430,346 to Johnson (1995). A spark plug with a ground electrode concentrically disposed to a central electrode and having precious metal on the firing surfaces.

A spark plug for an internal combustion engine wherein a ring-shaped ground electrode has a uniform annular hole with an internal diameter about 0.80 to 1.25 times the outer diameter of the center electrode. The ground electrode is vertically spaced below the center electrode and is concentric therewith. The ground electrode is connected to one or more mounting posts attached to a spark plug metal housing. Firing surfaces of the ground and center electrode have platinum alloy inserts laser-welded in place. The spark from the center electrode to the ground electrode has multiple paths and results in a spark plug which improves fuel combustion, increases gasoline mileage and engine horsepower and torque and significantly reduces the smolder time or ignition delay time and consequently reduces environmental pollutants of nitrogen oxide, carbon monoxide and other hydrocarbons. It does not consist of that which is now in this Kolp patent application.

One method used to manufacture a spark plug is shown in U.S. Pat. No. 6,080,029 to Johnson (2000), where is described a spark plug for internal combustion engines with only a double-ringed ground electrode permanently affixed to the spark plug base. One ring is used for the attachment and the other, held apart by one or more legs, is suspended circumferentially perpendicular to the longitudinal axis of the spark plug a set distance from the center electrode.

The method of manufacturing that specific spark plug is comprised of several steps providing a spark plug base, providing a ring-shaped ground electrode with enhancements to accomplish shielding and centering of the piece, providing a welding apparatus for rotateable welding of said ring-shaped ground electrode to said spark plug base, providing an alignment tool for aligning said ring-shaped ground electrode with said spark plug base and welding the ring-shaped ground electrode to said spark plug base to form a spark plug. It does not consist of what is now contained in this Kolp patent application, with its many improvements and benefits.

A similar prior patent to U.S. Pat. No. 5,280,214 is Australia Patent Number AU-B-75309/91 to Johnson (1993), for an internal combustion engine spark plug having a metal housing at least partially enclosing an insulator containing a conductive center electrode, the center electrode having a bottom end in the form of a sold cylinder extending from the insulator at the bottom end of said spark plug; the bottom end of the center electrode being spaced from a ground electrode attached to the metal housing, the improvement wherein the ground electrode is ring shaped and attached to the metal housing by at least one integral mounting post, with the top of the ground electrode being vertically spaced from a bottom end of the center electrode and an inner circumference of the ground electrode being concentric with the center electrode, the inner circumference of the ground electrode being uniform and having a diameter ranging from 0.80 up to 1.25 times an outer diameter of the center electrode. It does not consist of what is now in this patent application.

Another reference is the Canada Patent Number 5,280,214 issued 26 Dec. 26, 2000; which describes a spark plug for an internal combustion engine having a metal shell enclosing a ceramic insulator containing a conductive center electrode having a bottom end exiting from the insulator. The bottom end of the center electrode is spaced apart from a ground electrode attached to the metal shell by at least one support member or mounting post. The ground electrode is again only a ring/open-ring shaped and its interior diameter ranges from equal to the exterior diameter of the center electrode to a multiple of the size of the interior diameter of the center electrode. It does not contain/consist of what is now in this Kolp patent application.

There is also a European Patent specification Number PCT/EP90/01 738 for a spark plug with an open ring shaped ground electrode dated 27 December 1995, Patent Specification published: 27.12.95 Bulletin 95/52. Not consisting of what is now in this patent application.

There is also a France Patent Number UPI-Fre-1/US 738 for a spark plug with an open ring shaped ground electrode dated 27 December 1995, Patent Grant published in European Patent Bulletin: number 95/52 of 27 Dec. 1995. This specific reference is titled in the French language as: “BOUGIE D'ALLUMAGE DOTEE D'UNE ELECTRODE DE MISE A LA TERRE EN FORME D'ANNEAU OUVERTT”. It does not consist of what is now in this patent application.

There is also a United Kingdom Patent Number WO 91/06142 for a spark plug with an open ring shaped ground electrode dated 27 December 1995, Patent Grant published in European Patent Bulletin: number 95/52 of 27 Dec. 1995. This specific reference is titled SPARK PLUG WITH A RING/OPEN-RING-SHAPED GROUND ELECTRODE; that specifically describes particularly only a spark plug for an internal combustion engine having a metal shell enclosing a ceramic insulator containing a conductive center electrode having a bottom end exiting from the insulator. The bottom end of the center electrode is spaced apart from a ground electrode attached to the metal shell by at least one support member or mounting post. The ground electrode is ring/open-ring shaped and its interior diameter ranges from equal to the exterior diameter of the center electrode to a multiple of the size of the interior diameter of the center electrode. It does not consist of and encompass that which is specifically contained now in this Kolp provisional patent application.

There are also other references now known to this inventor and provisional patent application applicant, these are specifically German Patent Number DE 690 24 480 T2; titled in German “ZÜNDKERZE MIT EINER MASSENELEKTRODE IN FORM EINES OFFENEN RINGERS”, date of patent: 15 May 1996.

It is described and summarized in the German language as follows:

Anmarkung: Innerhalb von neun Monaten nach der Bakanntmachung des Hinweises auf die Ertailung des europaischan Patents kann jedermann beim Europaischen Patentamt gagen das ertailte europaische Patent Einspruch ainlegan. Dar Einsprusch ist schrift einzureihen und zu begruden. Er gilt erst ais eingelegt, wenn die Einspruchsgebuhr entrichtet worden ist (Art. 99 (1) Europaisches Patentubereinkomman.

It does not consist of nor encompass that contained now in this Kolp patent application. There are also other references now known to this inventor and provisional patent application applicant, these are specifically Mexico Patent Number 182430; titled in Spanish language, date of patent: 15 May 1996. It is titled in the Spanish language as follows: “BUJIA CON UN ELECTRODO A TIERRA DISPUESTO CONCENTRICAMENTE A UN.”

It is described and summarized in the Spanish language as follows:

Esta patente concede a su titular el derecho exlusivo de explotacion del invento reclamado en el capitulo reivindicatorio Y tiene una vigencia de veinte años improrrogables contados a partir de la fecha de presentatacion de la solcitud.

It does not consist of nor encompass that now contained in this Kolp patent application.

Objects and Advantages.

The objects and advantages of this new comprehensive design and unique manufacturing configuration process will also incorporate and demonstrate an improved satisfactory spark plug and engine ignition system electrode(s) which can be efficiently manufactured and can be accomplished by fuse-weld connection continuity/welding of a wire around the center electrode. Which in a variant of this novel patent design configuration will result in improvements in the electron flow or spark to emanate or to “ramrod” “shoot-out” like a “shooting star or rocket” in comparison to all conventional and all prior spark plug designs, configurations and engine ignition system performance and operation(s).

Spark plug and ignition system precision can also be enhanced uniquely as the result of this new novel and piezo-electric enhanced spark plug and ignition design configuration in combination.

This new spark plug design will uniquely demonstrate new and novel characteristics and performance including resistance to carbon-fouling across a spectrum of RPMs and vehicle or engine loads, that may result in virtually a non-fouling metal configuration design and chemical formulation and new metal alloy(s) designation as the Gold Star Highest-Performance Spark Plug. Specifically, the invention is for an improved higher-performance spark plug and engine ignition system, employing the inventor's improved spark plug design, utility configuration(s) and engine ignition system using piezo-electric enhancement configuration(s) and component(s).

Advantages.

It provides a more efficient spark from the center electrode(s) to the ground electrode(s) plus has multiple paths and results in one or more improvements—which should improve fuel combustion, increase gasoline/fuel mileage and engine horsepower and torque, also significantly reduce the smolder time or ignition delay time and consequently reduce environmental pollutants of nitrogen oxide, carbon monoxide, and other hydrocarbons and byproducts including the carcinogenic cancer-causing aldehyde(s), etc.

The invention of the above application may materially contribute to the more efficient utilization and conservation of energy resources by contributing to the reduction of energy consumption in combustion engines and industrial equipment, etc.

The invention of the above application may materially enhance the quality of the environment of human kind by reducing future pollution and contributing to the restoration or maintenance of the basic life-sustaining natural elements of air and water in the manner described below.

In many instances, the innovative piezo-electriomic© portion of this invention may also now uniquely provide improved specified plus fixed total optimal combustion data inputs and adjustments for many different specific engines, i.e., snow-blowers, snowmobiles, jet skis, certain generator engines, ground-based compressors and many others, eg., 4-cylinder 4-stroke gasoline engines, 6-cylinder, 4-stroke gasoline engines, 8-cylinder 4-stroke gasoline engines, aircraft engines, pumping station motors fueled by natural gas, and also 2-cylinder and single-cylinder 2-stroke engines, etc.

Because this improvement now comprises its open flame design and its plasmic-corona-like features. this invention may burn and chemically oxidize gasoline and certain other hydrocarbon fuels 20% to 50% or more faster, which can also permit the more favorable timing of the engine(s); while further lowering both emissions and fuel consumption and also yielding improved relative horsepower and performance.

The spark kernel generated by this new improved spark plug and ignition system method invention is more significant, substantial and larger than other plug(s). This results in more relative flame turbulence inside the specific engine cylinder(s). This improved spark plug invention alone by itself may now also do somewhat what the vortex engine does—only now in all or almost all engine design(s) and configurations, etc.

This invention may also provide a unique piezo-electric converter, that may variously be connected to high frequency current supply with the purpose and result of intensification of the combustion process(es) more efficiently, etc.

The invention is also relevant to the engine, burning any fuel at any speed(s), as it may also be used to improve combustion engine ignition in the winter period(s) and also anytime for self-cleaning of any carbon or unburned fuel deposition(s) on the spark plug electrodes when the engine is operating at all RPM levels—thus also reducing environmental pollution in this manner, in comparison to prior art for spark plug(s) and prior engine ignition configuration(s), etc.

It provides a more efficient spark from the center electrode(s) to the around electrode(s) plus has multiple paths and results in one or more improvements—which should improve fuel combustion, increase gasoline/fuel mileage and engine horsepower and torque, also significantly reduce the smolder time or ignition delay time; and thus may consequently result in increased reductions to total fuel consumption per mile(s) traveled, hundreds of horsepower produced, per measured torque pounds delivered to a drive-train, per hour(s) of engine operation, etc.

### SUMMARY

This new engine spark plug(s) invention and ignition system components invention specifically contemplated in this patent and this application for patent protection demonstrate and result in the reduction-to-practice of a new higher-performance and higher-efficiency long-life spark plug that the inventor now designates and plans to commercially market world-wide as the “All American Gold Star Highest-Performance Spark Plug” and the “All American Gold Star Shooting Star Piezo-Electric Ramrod Engine Ignition Enhancement System” and/or wording variations.

Prior patented inventions usually related only to spark plugs with a unique design of the tip or ground electrode. The spark plug tip is a circular ring that is attached to the plug body via three legs. This new design provides for more consistent and precise firing than the traditional spark plug design—because the plug fires all around the ring versus in one location and across a single straight line of 90 degrees or 120 degrees as does the traditional and conventional spark plug design. The circular ring design in operation results in more rapid ignition and a more consistent and efficient burning/oxidation of the compressed air/fuel mixture(s) inside the engine combustion chamber cylinders, etc.

The inventor here also proposes a further improved variant with a unique alloy formula and a center electrode alternative or central area electrode conductivity portion/component—that is both a plug-wire and will also act somewhat as a coil on one end; with the other end, the sparking end, being a ball-like design dipped in 0.010 platinum metal-coating. Versions or simply different product catalogue types and models of this same invention may not require the platinum coating or content, as the proposed alloy formula itself may operate with such levels of improved ignition and air-fuel oxidation as to remain clean of any significant deposits or other contaminant(s), so this new spark plug will also remain serviceable and most satisfactorily performing for more than 100,000 miles and perhaps 200,000 miles of vehicle engine operation.

With the 0.010 platinum metal-coating and the equivalent alloy formula also described in the paragraph above, this new design center electrode this new invention also proposes the additional improvement over prior conventional approaches of spark plug design, practical engine ignition system operation and functioning as well as the proposed original and novel innovation of casting in a mold the entire spark plug body, in such a manner of improvement(s) that the heretofore standard process of subsequently laboriously machining-out the bolt portion threads [i.e., to fit the configurations of specific engine types and English or metric specifications] will not be needed nor required to produce this new spark plug invention; and its design and manufacture to also newly now incorporate both piezo-electric component(s) and phenomenology.

This new generation of engine spark plug(s) and ignition system components conceived by this inventor will also result in and demonstrate that various engines utilizing this invention will have a more sustained and higher sustained engine performance and longer component(s) life cycle; for example, the new Gold Star Highest-Performance Spark Plug will still be performing at the same or near equivalent the same efficiency at 15,000 miles, 35,000 miles, 50,000 miles, 70,000 miles and 100,000 miles, as when the same set of spark plugs were first installed in the same engine(s). This new spark plug design will uniquely demonstrate new and novel anti-aging spark plug characteristics and improved durability performance and longevity over prior spark plugs.

This new spark plug design will also demonstrate novel characteristics and performance, such as less carbon deposits and build-up on the spark plug, and the cylinder rings or equivalent locations in many of the different engine types and configurations in which these new spark plugs are installed and will be installed. This and other attributes constitute a new and novel improvement.

With the addition of specified copper component(s) in the bulk of the steel alloy casting, the entire length of this new spark plug, so that uniquely the transfer of electrons and electrical flow of energy will be enhanced and more rapid into the combustion chamber of any specific engine(s) in which it/they are installed.

This new spark plug design and its manufacturing casting will uniquely demonstrate new improvement over all conventional and prior art spark plus and novel process, procedures, methods, and approaches.

This new spark plug design will uniquely demonstrate new and novel characteristics and performance that will also include sustained high-performance at high vehicle speeds and high engine revolutions per minute (RPMs).

### DRAWING(S)

Drawing Figures

FIGS. 1 thru 6 are drawings of the fundamental design and engineering of the “All American Gold Star Highest Performance Spark Plug”)© invention and “Gold Star Shooting Star Piezo-Electric Ramrod Engine Ignition Enhancement System”© invention and/or variations of this wording and equivalent wording and descriptions; such as the “Gold Star High Performance Plasmic Spark Plug” and “Plasmic Ramrod Shooting Star Piezo-Electriomic Plasmic Spark Plug and Ignition System”© “Ramrod Engine Ignition Enhancement System” © and equivalent language descriptions, designations and terminology. [Copyright 2003, T. J. Kolp, All rights reserved.].

### REFERENCE NUMERALS IN DRAWINGS

1 insulator cast alloy and/or injected in mold from “Space Age Materials” that are dialectrical and high temperature(s) tolerant and strengthened.
2 metal shell plus ground electrode [cast and manufactured in one piece in this manufacturing process patent portion].
3 center electrode component and portion (s).
4 component device for centering.
5 super-conductive “Gold Star” central core material and area arrangement.
6 polymer and wax injection assembly component locations.
7 holding and alignment component and device fixture.
8 electrode protrusion for coupling and attachment of ignition wire mechanism.
9 internal seals and external heat insulation/dissipation capacitor.
10 piezo-electric engine ignition enhancements connectivity and conduction component/apparatus.
11 center electrode.
12 piezo stack at tip of a grounded electrode.
13 insulator.
14 shell casing electrically and thermetrically conductive.
15 grounded oval circular electrode.
16 ignition controller/micro-processor and engine timing input regulator.
17 piezo-electric/piezo-electriomic stack© [Copyright T. J. Kolp, 2003] inside spark plug boot.
18 A. in-put driver.
18 B. Kolp Gold Star spark plug(s).
18 C. high frequency driver as the Kolp piezo-electric/electriomic© stack near the tip of spark plug.
19 A. Kolp plain piston position mounted protruding ground electrode ©, i.e., without and absent any piezo-electriomic plasmic© component(s). [Copyright T. J. Kolp, 2003]
19 B. engine piston(s).
20 A. in-put driver.
20 B. Kolp Gold Star spark plug(s).
20 C. high frequency driver as the Kolp piezo-electric/electriomic stack near the tip of spark plug.
21 A. Kolp enhanced piezo-electriomic component piston position mounted protruding ground electrode© [Copyright T. J. Kolp, 2003], i.e., with and also having and utilizing Kolp piezo-electriomic plasmic component(s).
21 B. engine piston(s) as seen in part inside the specific individual engine cylinder(s) and combustion chamber(s).
22 A. in-put driver location.
22 B. Kolp Gold Star spark plug(s).
22 C. high frequency driver as the Kolp piezo-electric/electriomic stack near the tip of spark plug.
23 A. Kolp enhanced piezo-electriomic contoured component piston position cast mounted into the engine piston(s) as the ground or target electrode© [Copyright T. J. Kolp, 2003].
23 B. Kolp contoured engine piston(s) with appropriate simple contour(s) to optimal locate and position ground[ed] or target electrode(s) perimeter(s) plus contour pioston(s) will optimize
24 both fuel/air compression(s) and expansion portions of fuel/air explosive expansion(s) in engine operating cycles.© [Copyright T. J. Kolp, 2003; All rights reserved.].
25 A. fine metal(s) and element(s) powder are combined/compounded with polymer binder(s), etc.
25 B. combined mixtures of fine metal powder(s) and/or granules are appropriately granulated to specific alloy(s) and other formulas, etc.
25 C. feedstock(s) are formed and made available for novel items metal casting and manufacturing proposed and described in this provisional patent application of Colonel Terry Kolp.
26 A. metal(s) and element(s) granules in primary production and manufacturing process step, as appropriate and consistent with preferred methodology, are gathered together, etc.
26 B. injection mold design and production procedure(s) and manufacturing process step that combines several components and equivalent spark plug items/features into fewer and one, as referenced and described above and below herein in poprtions of the Background, Summary, Description(s), Invention Formula, Abstract and claims.
26 C. solvent debind[ing] process step.
26 D. thermal debind[ing] process step.
26 E. sinter[ing] process step.

### DETAILED DESCRIPTION(s)

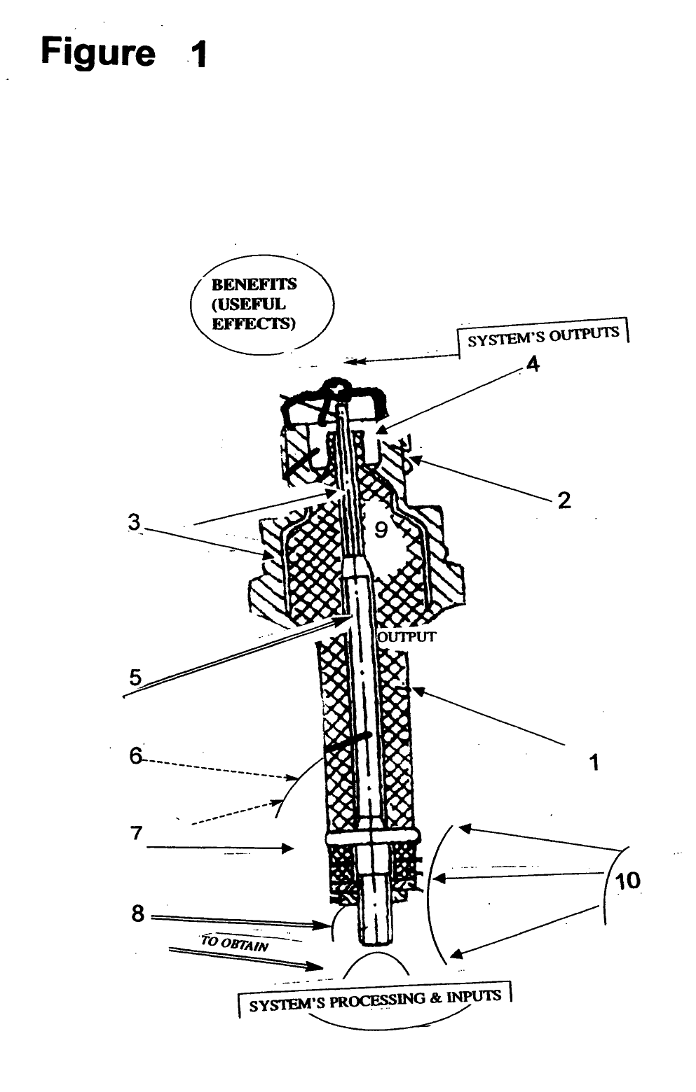

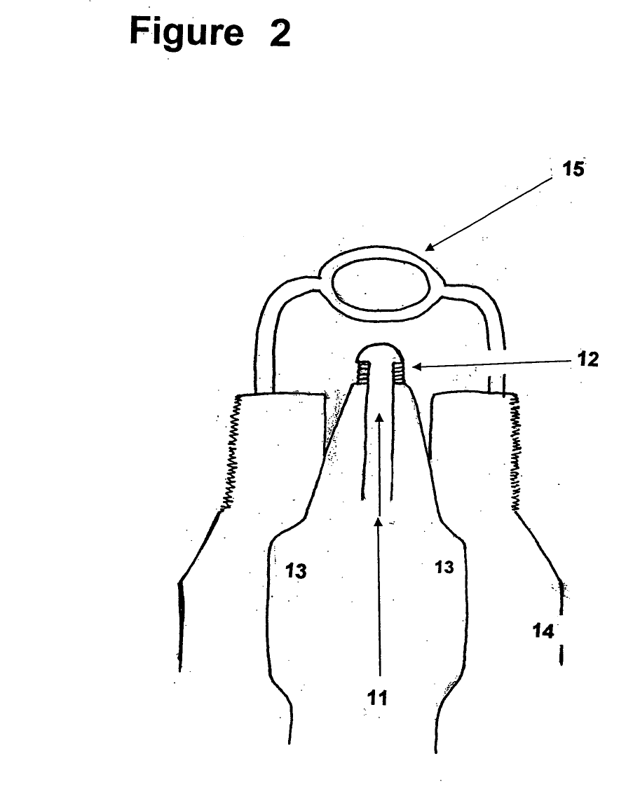

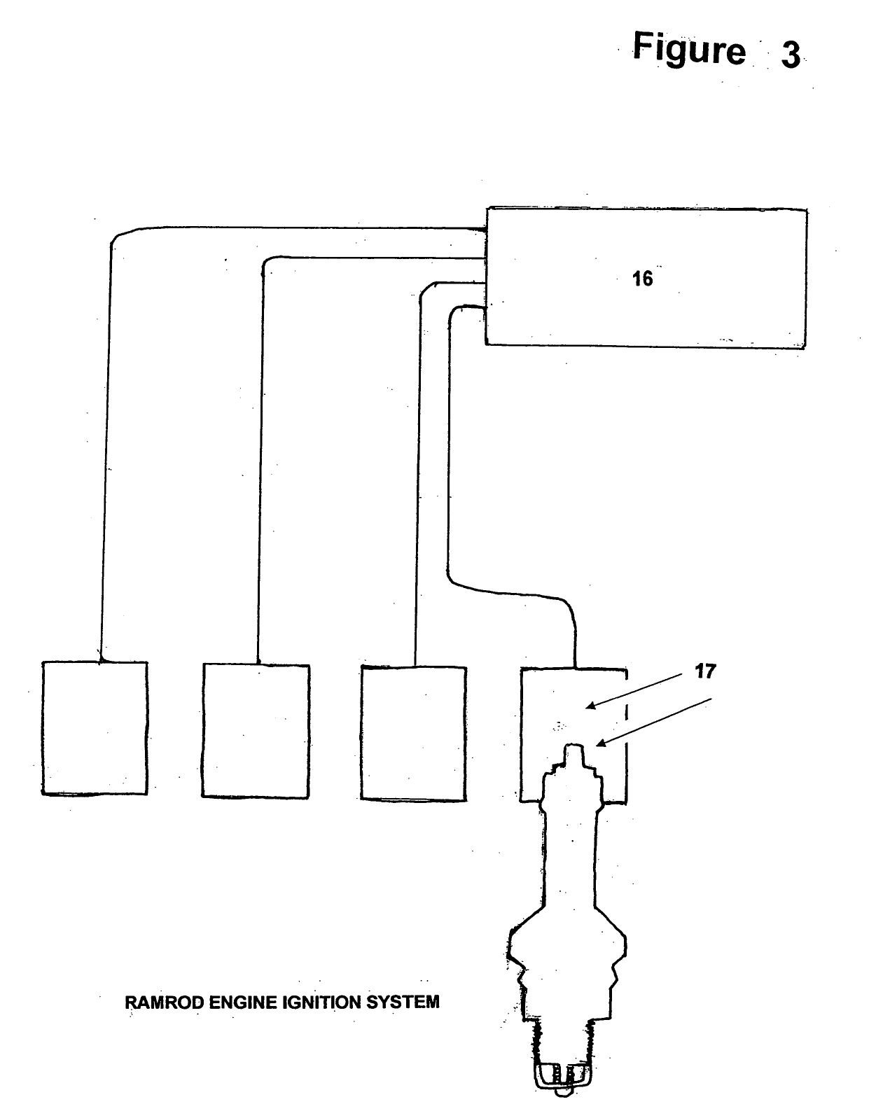

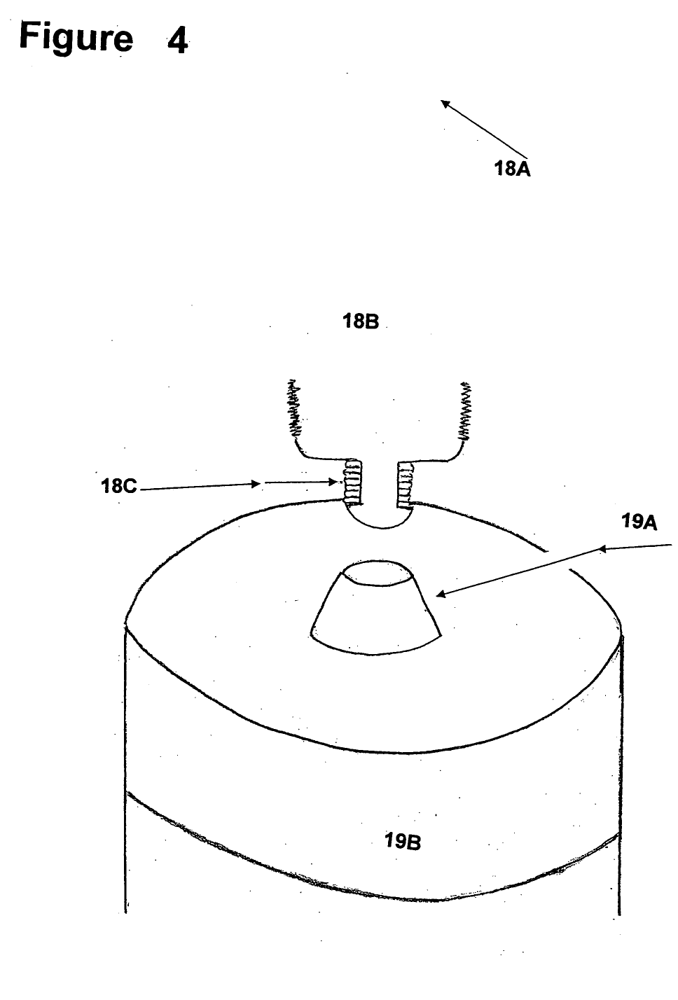

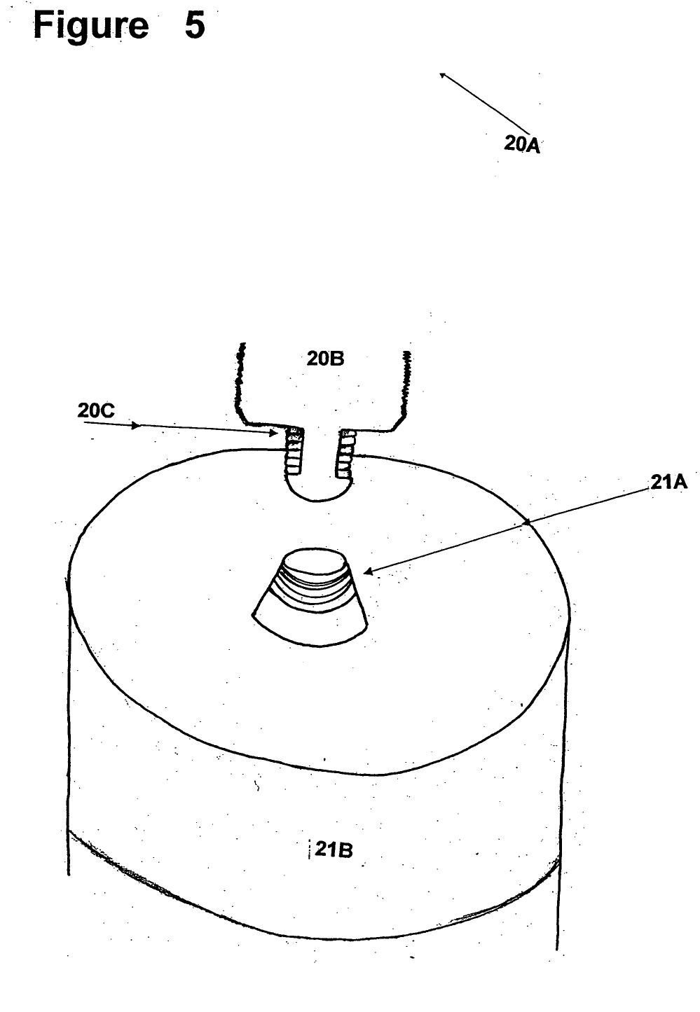

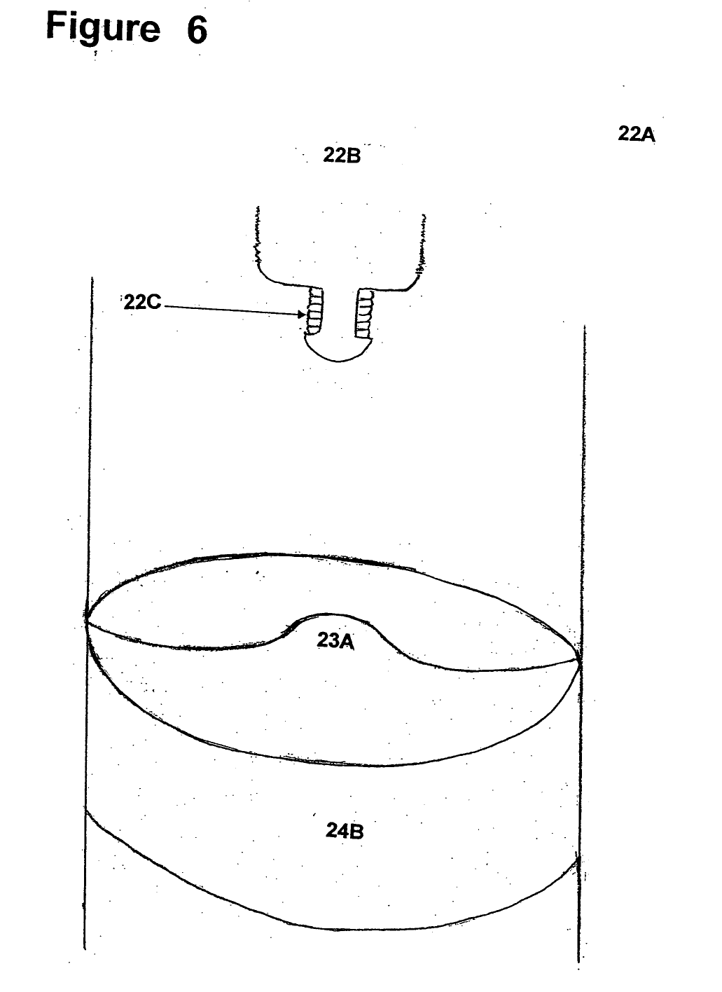

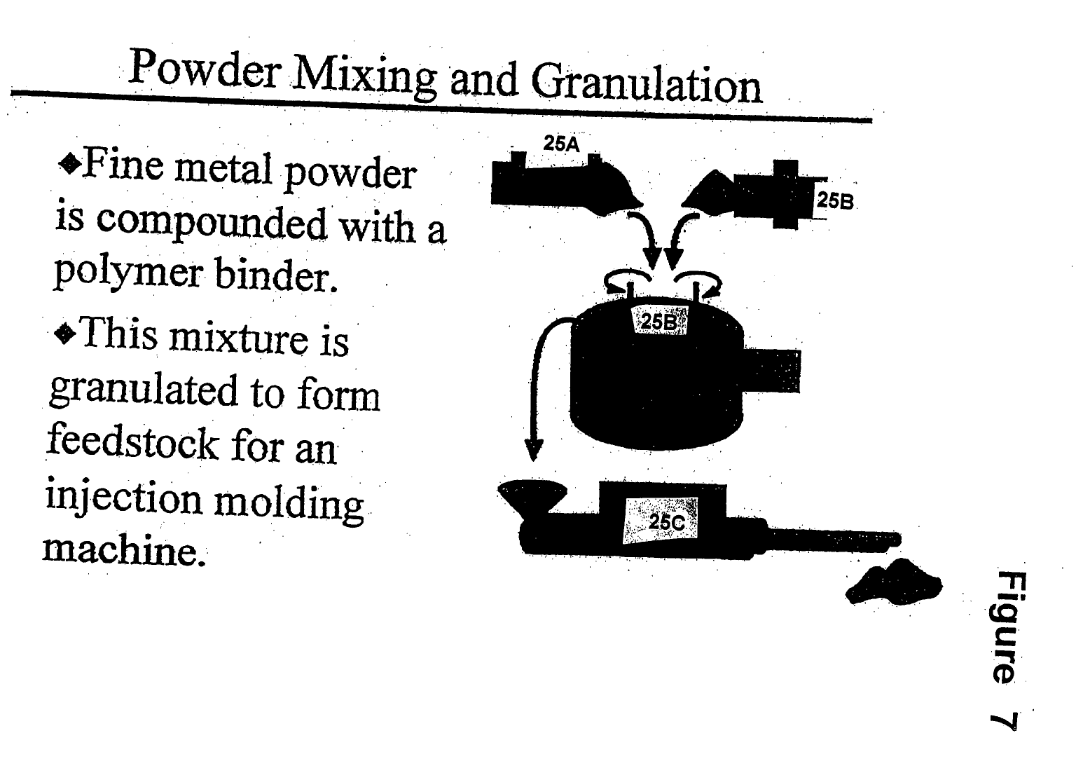

Description—FIG. 1 is a full length lateral internal side-view drawing of the Kolp Spark Plug invention(s) component(s) and also references sub-components and the location(s) of processing inputs and system outputs for the “Kolp Gold Star Highest-Performance Oval Ground Spark Plug” invention and “Gold Star Shooting Star Piezo-Electric Ramrod Engine Ignition Enhancement System” invention.

The upper portion as shown and labeled is comprised of an insulator cast alloy and/or injected in mold from specified adhesives, that are dialectrical and high temperature(s) tolerant and strengthened; containing a metal shell plus ground electrode [cast and manufactured primarily in one-piece in this manufacturing process patent portion], with a centered area of an electrode component and portion set in place and alignment by use of a component device for centering.

The use of the specified adhesives here for this spark plug invention and design is novel and also constitutes a new improvement(s) in both spark plug utility design and useful functioning operation for ignition of various fuel/air mixtures.

The use of the specified adhesives here for this spark plug invention, its design and the herein described and disclosed manufacture, assembly, and industrial production of a spark plug also constitute distinct new improvements is novel and also constitutes a new improvement(s).

Also shown in the drawing and labeled in FIG. 1 is this invention's super-conductive “Gold Star” central core material (s) and area arrangement and the herein now also proposed polymer and wax injection assembly component location(s) for the holding and alignment of component(s) and device fixture.

At the lower portion of the drawing labeled FIG. 1 are several items, some of which are unique and/or in an original and novel configuration(s) proposed in this patent application for electrode protrusion for coupling and attachment of ignition wire mechanism(s), internal seals and external heat insulation/dissipation capacitor, and this patent's distinct and original piezoelectric engine ignition enhancements connectivity and conduction apparatus.

Thus, also combining several components and equivalent spark plug and ignition items/features into fewer and one, as referenced and described above and below herein in portions of the Background, Summary, Description(s), Invention Formula, Abstract, etc.

FIG. 2 is a partial full-view drawing of the Kolp Oval Ground Electrode Piezo-Electriomic Spark Plug© invention component variant alternative—this concept and invention now having optional enhancement(s) of a piezoelectric stack sub-components at the firing tip of this the “Kolp Gold Star Highest-Performance Oval Ground Electrode Piezo-Electro Plasmic Spark Plug©” to utilize the mechanical deformation for modifying the gap and to boost the voltage, improve the straight angle and desired angles of dispersions from the spark plug and the “Gold Star Shooting Star Piezo-Electric Ramrod Engine Ignition Enhancement System” invention.

FIG. 3 is a partial full-view drawing of the Kolp Piezo-Electric High Voltage Spark Plug on the End of the Kolp Piezo-Electriomic Ignition System Lead(s).©

This concept and invention uniquely incorporates a piezoelectric or piezo-electronic stack into the end of the spark plug lead. This design approach, solution and improvement is also intended to allow for the maximum life component, for example the spark plug itself or the lead wire(s) or the piezoelectric responsive and conductive stack itself, to not be changed nor require repair/replacement as frequently or soon or when the weakest link has to be serviced or replaced.

FIG. 4 illustrates as seen from inside the engine combustion chamber a partial side-view and partial top-view drawing of the Kolp Highest Performing Single Protruding Probe Plasmic Plug Variable Gap and Variable Voltage Configuration Design With Corresponding Piston Positioned and Located Protruding Ground Electrode(s)© [Copyright T. J. Kolp, 2003].

Note: First the protruding tip of this specific spark plug Kolp variant configuration from above in this FIG. 4 drawing with its piezoelectric stack washer style or type disks in a piezo-electronic or piezo-electriomic© [Copyright T. J. Kolp, 2003] washer style or round configured type disks; and secondly, shown is the inventor's location and configuration for the piston mounted ground electrode(s).

This concept design approach, solution and improvement invention incorporates and utilizes the top of the piston for the the ground electrode target for both a non-piezoelectric basis Kolp Spark Plug and also the option alternative of the Kolp Piezo-Electriomic Spark Plug© [Copyright T. J. Kolp, 2003] being a piezo-electronic stack controlled and enhanced electron energy flow or charge to adjust the point of initiation of the spark and timing and the duration in nano-seconds of how long the spark is sustained at each appropriate RPM interval and engine cycle. In addition, it can also be utilized computer logic initiation of the spark [timing] and duration, etc.

FIG. 5 illustrates as seen from inside the engine combustion chamber a partial side-view and partial top-view drawing of the Kolp Highest Performing Single Protruding Probe or Prong Kolp Piezo-Electriomic© Spark Plug Variable Gap and Variable Voltage Configuration Invention Design With Protruding Piston Positioned and Located Ground Electrode(s).

Note: The protruding tip of this specific spark plug Kolp variant configuration from that above in the FIG. 4 drawing with its piezo-electronic or piezo-electriomic© [Copyright T. J. Kolp, 2003] features.

This variant may not always require piezoelectric stack washer style or type disks in a piezo-electronic or piezo-electriomic© [Copyright T. J. Kolp, 2003] washer style or round configured type disks, in some engine application(s). Significantly, shown here is the inventors location and configuration for this piston mounted ground electrode(s)© [Copyright T. J. Kolp, 2003] variant of this invention. This concept design approach, solution and improvement invention utilizes the top of the piston for a ground[ed] electrode target.

FIG. 6 illustrates as seen from inside the engine combustion chamber a partial side-view and partial top-view drawing of the Kolp Highest Performing Single Protruding Probe or Prong Kolp Piezo-Electriomic© Spark Plug Variable Voltage Configuration Invention Design With Smooth Contour Shaped Piston and Conforming Position Located Ground Electrode(s).

Note: The protruding tip of this specific spark plug Kolp variant configuration from that above in the FIG. 4 drawing with its piezo-electronic or piezo-electriomic © [Copyright T. J. Kolp, 2003] features.

This variant may not always require piezoelectric stack washer style or type disks in a piezo-electronic or piezo-electriomic© [Copyright T. J. Kolp, 2003] washer style or round configured type disks, in some engine application(s).

Significantly, shown here is the inventor's location and configuration for this contour shaped piston and Kolp enhanced piezo-electriomic contoured component piston position cast mounted into the engine piston(s) as the ground or target electrode conforming-mounted ground electrode(s)© [Copyright T. J. Kolp, 2003] variant of this invention. This concept design approach, solution and improvement invention utilizes primarily the top of the piston for a ground[ed] electrode target.© [Copyright T. J. Kolp, 2003].

FIG. 7. This illustrates and generally describes the steps and process for materials mixing and pre-casting the fine metal(s) and element(s) powder that are then combined/compounded with polymer binder(s) and combined mixtures of fine metal powder(s) and/or granules are appropriately granulated to specific alloy(s) and other formulation of materials and inventory to make spark plugs in general and this spark plug invention and its components in particular, etc. This then results in feedstock(s) are formed and made available for novel items metal casting and manufacturing proposed and described in this provisional patent application feedstock(s) are formed and made available for novel items metal casting, molding, and manufacturing proposed and described in this provisional patent application of Colonel Terry Kolp.

FIG. 8. This is a diagram and drawing of the Manufacturing Overview for industrial materials and inventory to make spark plugs in general and this spark plug invention and its components in particular, etc.

Operation All American Gold Star Highest Performance Spark Plugs©

In operation this new spark plug utility patent will demonstrate novel configuration(s), composition(s), characteristics and improved performance in normal operation and use. That will include the result that contemporary and prior engine designs, especially gasoline engines, may now burn a leaner fuel mixture than with other conventional or alternative prior spark plug configurations and designs; thus this invention will also demonstrate the benefit(s) of reduced fuel consumption(s), reduced combustion chamber residue from unburned or incompletely under oxidized hydrocarbon fuel(s) and lubricant(s) and correspondingly reduced amounts of by-product atmospheric pollution compared to all other known configurations and compositions of spark plugs. Specifically, current and prior spark plugs rely upon carburetion and fuel injection components that maintain on average an air/fuel ratio (AFR) of 14.7 parts ambient air to one part gasoline fuel. However, this new Gold Star Highest Performance Spark Plug design will now allow the same many different gasoline engine types, models and designs to utilize more efficient air/fuel ratios, resulting from just the installation of this new spark plug invention and the normal adaptation(s) of the previously-installed conventional-designed on-board microprocessors/vehicle engine computer such that increases to 15.0 parts, 17.0, 18.0 and up to 20.0 parts of air to one part of fuel will be the demonstrated result and part of the uniqueness claimed in this patent, etc. Thus, the APR using this new spark plug invention will be on the order of 20.0 parts of ambient air to only one part of fuel, such an APR ratio is an average improvement of 20.0 minus 14.7 equals 5.3 which is a fuel consumption reduction factor of 36.05 percent to 26.50 percent, etc.

This new spark plug design will uniquely demonstrate new and novel characteristics and performance, including the requirement for less start-up ignition voltage to the engine(s); that will result in faster and better engine starting in extreme cold temperatures, higher altitudes and other extreme conditions; such that a demonstrated advantage of this new spark plug and ignition system will be less wear on all of the ignition systems; such as starter motors, batteries, battery wires and ignition wires and, in turn, will result in less maintenance requirements for these components of all vehicle types and engine designs in which the “All American Gold Star Highest Performance Spark Plug” and the “Gold Star Shooting Star Piezo-Electric Engine Ignition Enhancement System” are installed.

This new spark plug novel design and novel configuration is adaptable to many different specific engine internal combustion configurations, such as specific cylinder shapes, proportional distances, cubic volume measured in inches or liters metrically, so that this new spark plug design and its unique multiple different configurations will adapt or be adapted for the ideal and optimal heat range and spark plug gap or equivalent to spark plug gap.

Such that much more and, in many instances, total optimal available and efficient combustion can be specified for many different specific engines, i.e., four-cylinder four-stroke gasoline engines, six-cylinder, four-stroke gasoline engines, eight-cylinder four-stroke gasoline engines, aircraft engines, pumping station motors fueled by natural gas and also two-cylinder and single-cylinder two-stroke engines such as now used for snow-blowers, snowmobiles, jet skis, certain generator engines, ground-based compressors and many others.

Design of the plug exposes the inputting electron(s) flow of energy more efficiently to the compressed fuel/air mixture(s) in the cylinder. This is instead of keeping it as much as previously contained within and under the spark plug side wire area.

Because of the open flame design and its plasmic-like features, this invention burns and chemically oxidizes gasoline and certain hydrocarbon fuels 20% to 50% or more faster, which permits the favorable timing of the engine; while lowering both emissions and fuel consumption and also yielding improved relative horsepower and performance.

The spark kernel generated by this plug is more significant, substantial and larger than any other plug. This results in more flame turbulence inside the cylinder. The plug does what the vortex engine does—only in all or almost all engine design(s) and configurations.

This plug design results in high-performance similar to that achieved when a mechanic indexes the race electrode opening of each conventional spark plug used in competition racing vehicles with the intake valve to provide—an optimum burn pattern opportunity.

### CONCLUSION, RAMIFICATIONS, AND SCOPE

In conclusion, insofar as I am aware, no internal combustion engine burning conventional petroleum based hydrocarbon fuels or any other fuels has yet available spark plug(s) or an ignition system presently available that consists of or is designed, arranged, operates as precisely and with the specific features, enhancements and improvements as well as the specific resultant performance characteristics and benefits of this subject provisional spark plug patent(s), written by the applicant.

In further conclusion, insofar as I am aware, no other spark plug or ignition component(s) is/are manufactured nor proposed to be manufactured, molded, cast, assembled, fitted and produced by the same method, processes, procedures, and improvements as is/are described in this patent application.

Description and Advantages

Essence of the “Plasmic Ramrod Shooting Star Piezo-Electric Ramrod Engine Ignition Enhancement System” and equivalent portion of these invention(s) consists of: the metal case portion of the spark plug is insulated from the central electrode with the insulator portion(s). At the end of the case, there is a lateral electrode portion. Contact rod of the central electrode goes through the stack of piezo-electric washers and the metal washer with a hold which all are rigidly fastened on the rod by the nut. A unique piezo-electric converter is connected to high frequency current supply with the purpose and result of intensification of the combustion process. An electromechanical converter is located far from the hot region of the engine and the rod is also utilized as a the rod of the piezo-electric converter.

The invention is relevant to the engine building and can be used to improve combustion engine ignition in the winter period and also for self-cleaning of any carbon or unburned fuel deposition(s) on the spark plug electrodes when the engine is operating at all RPM levels.

It is known the design of a spark plug with a case and a lateral electrode and a central combustion capacity due to the growth of a deposition on the electrodes (snuff) and also because when starting, most of the energy goes into evaporation of the droplets of the fuel from the electrode surface(s).

Closest to the claimed invention is the spark plug for a combustion engine, which has a case with a lateral electrode, central electrode and an excitation coil, installed on the outer part of the central electrode. Part of the central electrode is made of a magnetostriction or magneto-restrictive material(s). This spark plug has enhanced firing capacity due to intensification of the process of ignition by ultrasonic oscillations. However, dimensions and mass of the spark plug may increase due to the large excitation coil. In addition, heat from the hot zone may affect reliability of the converter. Shielding of the spark generating and electromechanical parts that the converter requires may further increase the dimensions and the mass of the spark.

The purpose of this invention or this portion of this Kolp invention—is improving the dimensions and mass characteristics and enhancement of the combustion conversion of the air/fuel mixture by the explosive oxidation contained within the respective combustion chamber(s).

This goal is achieved by this Kolp utility invention design—that is now a more comprehensive spark plug for combustion engine(s) having a case with the lateral electrode, central electrode with the contact rod; electromechanical converter which is made of a stack of piezo-electric washers and metal washer with the hole; all washers are firmly clamped on or adjacent to the central electrode rod.

The essence of the invention Is in separation of the thermal and mechanical plug action without increase of the mass and dimensions and also in use of the central electrode rod as a the rod to clamp or mount and align a piezo-electric converter, which allows to improve mass and dimensional characteristics and enhance reliability of the spark generation.

Characteristic features of this/these invention(s) are:
Design and inclusion of electromechanical converter as a stack of piezo-electric washers on the central electrode rod; with the option alternative of also elsewhere.
Rigid fastening of the converter by the central electrode contact rod.

FIGS. 1 thru 8, as Drawing(s) illustrate this/these spark plug and ignition invention(s) and also the casting and manufacturing process steps in sequence, etc. Spark plug comprises the metal case which is isolated from the central electrode with the insulator. At the edge of the case, there is a lateral electrode. Spark plug contains also an electromechanical converter which enhances the spark generation and it comprises a stack of the piezoelectric washers with common insulated electrode and metal washer with the hole. Piezo-electric washers and metal washer are rigidly clamped by the nut secured on the threaded end of the contact central electrode rod.

Piezo-electric washers are made of material and are charged with high frequency generator (not shown); one of the terminals is connected to the central electrode, the second one is connected to the electrode. Dimensions of the elements of the spark plug and their configuration are chosen such that the spark performs as an acoustic resonator with concentration of the ultrasonic oscillations at the tip of the electrode. The spark seals are located in the knots of the standing ultrasonic wave.

The spark plug operates and specifically performs as follows:

When high voltage is supplied to the electrode and when electric voltage reaches the breakdown threshold, breakdown occurs. Since piezoelectric washers are charged with the high frequency, they generate acoustic oscillations of the electrode and insulator, cleaning them from the snuff. Also, the process of combustion is enhanced due to better missing of fuel droplets with the air in the zone of the breakdown discharge. At the superposition of the ultrasound on the spark, it generates high pressure and temperature in excess of 10,000 degrees C. Ionization of the evaporated electrode and therefore origination of plasma creates conditions which guarantee reliable ignition of the fuel-air mixture. That is how combustion performance is improved many fold.

The proposed spark plug invention also has improved mass-dimensions characteristics which are obtained by replacement of the electromechanical converter from the hot zone of the engine and also by using the central electrode rod as a tie rod for the piezoelectric converter stack.

Invention Formula:

The improved spark plug for a combustion engine comprising a case with the lateral electrode, insulator, central electrode with the contact rod and electromechanical converter, connected to the high frequency current supply, serving to enhance the spark being an electron flow which distinguishes that with the purpose of improving of the mass-dimensional characteristics and reliability; the optional electromechanical converter(s) is/are made as a stack of piezo-electric washers and metal washer with a hole, and metal washer and a piezo-electric washers are rigidly secured on the central electrode rod—in a novel arrangement(s) and unique designation and novel application(s) that the inventor designates now piezo-electriomic and plasmic©.

1. Specifically, a method for providing a higher-performance spark plug and engine ignition system, employing the inventor's improved spark plug design, utility configuration(s) and engine ignition system using piezo-electric enhancement configuration(s) and component(s); comprising:
a. a spark plug providing a more efficient ignition spark from its center electrode(s) to the ground electrode(s) using multiple paths;
b. also providing an open flame design which produces upon the electron flow(s) into and from this spark plug design and utility application plasmic-corona-like phenomena in the combustion chamber(s);
c. additionally providing for the spark plug burn which more efficiently chemically oxidizes hydrocarbon fuels and other flammables 20% to 50% or more faster;
d. additionally providing and permitting the more favorable timing of the engine(s); while further lowering both emissions and fuel consumption and also yielding improved relative horsepower and performance. Resulting from more complete and efficient electrochemical combustion and reduced amounts of remaining unburned fuel per cycle(s) at cc and ml levels @ under-utilized fuel atoms/molecules and byproducts pollutants, etc.

2. Specifically, a method and improvement utilizing a piezo-electriomic© portion incorporated into and adjacent to individual spark plugs mounted and seated correctly into an engine, comprising:
a. an invention also now uniquely providing improved specified plus fixed total optimal combustion data inputs and adjustments for many different specific engines, i.e., snow-blowers, snowmobiles, jet skis, certain generator engines, ground-based compressors and many others, eg., 4-cylinder 4-stroke gasoline engines, 6-cylinder, 4-stroke gasoline engines, 8-cylinder 4-stroke gasoline engines, aircraft engines, pumping station motors fueled by natural gas, and also 2-cylinder and single-cylinder 2-stroke engines, etc.

3. Specifically, a new and improved integration of a spark plug and ignition system which method generates a more significant, substantial and large spark kernel, which results in:
a. providing from the spark plug(s) a more relative flame turbulence inside the specific engine cylinder(s);
b. providing, in turn, a vortex-like effect at the corona and plasmic level of ions, emanating from the spark plug delivered electron flow, commencing and continuing to react with the air/fuel mixture;
c. providing, in turn, a localized vortex-like effect prospectively resulting in manifested correspondent fuel consumption reductions and various reduced bulk fuel requirements at various specific RPM speeds, engine temperatures, air/fuel mixtures, and combustion ratios, etc.
